(19) United States
(12) Patent Application Publication
(10) Pub. No.: US 2005/0206252 A1
(43) Pub. Date: Sep. 22, 2005

(54) Electric machine with improved cooling system, and method of cooling an electric machine

(75) Inventors: Klaus Georg, Salz (DE); Klaus Greubel, Bad Neustadt (DE); Jurgen Martin, Regensburg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/081,805

(22) Filed: Mar. 16, 2005

(30) Foreign Application Priority Data
Mar. 17, 2004 (DE) 10 2004 013 133.3

(51) Int. Cl. H02K 9/00

(52) U.S. Cl. 310/59

(57) ABSTRACT

An electric machine includes a housing defining an axis and having a coolant port disposed in an axial center of the housing, and a cylindrical stator surrounded by the housing and having a stator body in the form of a plurality of stacked laminations, with the stator having opposite axial ends terminating in winding heads. The housing and/or the stator is constructed to have cooling channels which extend in an axial direction and communicate with the coolant port to allow a flow of coolant from the coolant port via the cooling channels to the winding heads, or in opposite direction from the winding heads via the cooling channels to the cooling port.

### CROSS-REFERENCES TO RELATED APPLICATIONS

This application claims the priority of German Patent Application, Serial No. 10 2004 013 133.3, filed Mar. 17, 2004, pursuant to 35 U.S.C. 119(a)-(d).

### BACKGROUND OF THE INVENTION

The present invention relates, in general, to an electric machine with improved cooling system, and method of cooling an electric machine.

Nothing in the following discussion of the state of the art is to be construed as an admission of prior art.

Electric machines of high output power density require the provision of a special system to remove heat and thus are generally equipped with a cooling system by which air or other type of coolant is forced to circulate. German Pat. No. DE 43 11 431 C2 describes a cooling system with radial air channels which are realized by providing a stepped configuration of the active motor part in the form of sheets of different outer diameter or by forming radial grooves in the cooling housing which represents the passive motor part and surrounds the active motor part. Coolant flows in the axial center of the motor toward the radial cooling channels for inward conduction. From there, coolant is deflected outwards via particular guides.

Cooling systems can also have axial air guides in order to cool the stator in particular. These types of cooling systems are, however, unable to provide sufficient supply of unheated coolant to the winding heads which constitute hot areas in the active part of the motor, i.e. in the stator or rotor.

It would therefore be desirable and advantageous to provide an improved electric machine and an improved method of cooling an electric machine to obviate prior art shortcomings.

### SUMMARY OF THE INVENTION

According to one aspect of the present invention, an electric machine includes a housing defining an axis and having a coolant port disposed in an axial center of the housing, and a cylindrical stator surrounded by the housing and having a stator body in the form of a plurality of stacked laminations, with the stator having opposite axial ends terminating in winding heads, wherein the housing and/or the stator is constructed to have cooling channels extending in an axial direction and communicating with the coolant port to allow a flow of coolant from the coolant port via the cooling channels to the winding heads, or in opposite direction from the winding heads via the cooling channels to the cooling port.

According to another aspect of the present invention, a method of cooling an electric machine having a cylindrical housing in surrounding relationship to a stator includes the steps of directing a coolant into the housing in an area of an axial center of the housing, guiding the coolant in both axial directions to opposite winding heads of the stator, and routing the coolant through the winding heads radially inwards.

According to still another aspect of the present invention, a method of cooling an electric machine having a cylindrical housing in surrounding relationship to a stator includes the steps of directing a coolant (e.g. air) through winding heads on both axial ends of the stator radially inwards, guiding the coolant to an axial center of the stator, and routing the coolant from an area of the axial center of the housing to the outside. This type of coolant system realizes a maximum cooling effect because coolant flows first past the hot points in the area of the winding heads and subsequently through the stator body via parallel paths from the driving and opposite ends to the axial center of the electric machine. The windings heads and thus the hot points are cooled effectively, while the coolant undergoes a minimum heating along the remaining cooling path. As a result of a cooling system according to the present invention, the motor is able to run as effectively and as efficiently as a motor that is equipped with a water cooling system. The coolant path of the inventive cooling system also contributes to a compact overall construction and results in material savings.

According to another feature of the present invention, the coolant port may include plural apertures which are spaced about a circumference of the housing. Thus, coolant can be introduced into or removed from the electric machine evenly about the circumference.

According to another feature of the present invention, the cooling channels may be formed by axial grooves in the housing or in the stator body. In this way, the provision of axial cooling channels can easily be realized.

According to another feature of the present invention, a ring-shaped disk may be disposed between each one of the winding heads and the housing for forcing coolant to flow through the winding heads. As a consequence, coolant not only flows around the outside of the winding heads but also provides an effective cooling of the interior of the winding heads.

According to another feature of the present invention, the housing has end surfaces which may be formed with further coolant ports radially inwardly of the winding heads. The provision of these further coolant ports enables a direct conduction of coolant to the winding heads to realize a maximum cooling effect. As an alternative, or in addition, it may also be conceivable to provide further coolant ports with radial throughflow on one of the axial ends of the housing radially outwards of the adjacent winding head. In this way, coolant is directed at least partly about the outside of the winding heads, when the ring-shaped disk seals the winding heads against the housing, and the coolant flow is forced through the winding head. As a result, coolant is able to flow effectively about the entire winding head. A further optimization may be realized when the further coolant ports are arranged immediately adjacent to the ring-shaped disks in axial direction. In this way, coolant is, in fact, forced to flow almost entirely around the winding heads.

As noted, the coolant flow may be realized in both directions, although the inflow of coolant immediately adjacent to the winding heads is currently preferred.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross section of a first embodiment of an electric machine according to the present invention, taken along the line I-I in FIG. 2;

FIG. 2 is a partial side view of the electric machine from the right hand side in FIG. 1;

FIG. 3 is a front view of the electric machine from the left hand side in FIG. 1;

FIG. 4 is a plan view of the electric machine of FIG. 1;

FIG. 5 is a cross section of a second embodiment of an electric machine according to the present invention;

FIG. 6 is a partial side view of the electric machine from the right hand side in FIG. 5;

FIG. 7 is a front view of the electric machine from the left hand side in FIG. 5;

FIG. 8 is a plan view of the electric machine of FIG. 5;

FIG. 9 is a top perspective view of a third embodiment of an electric machine according to the present invention; and

FIG. 10 is a top perspective view of the electric machine of FIG. 9 with reversed coolant path.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

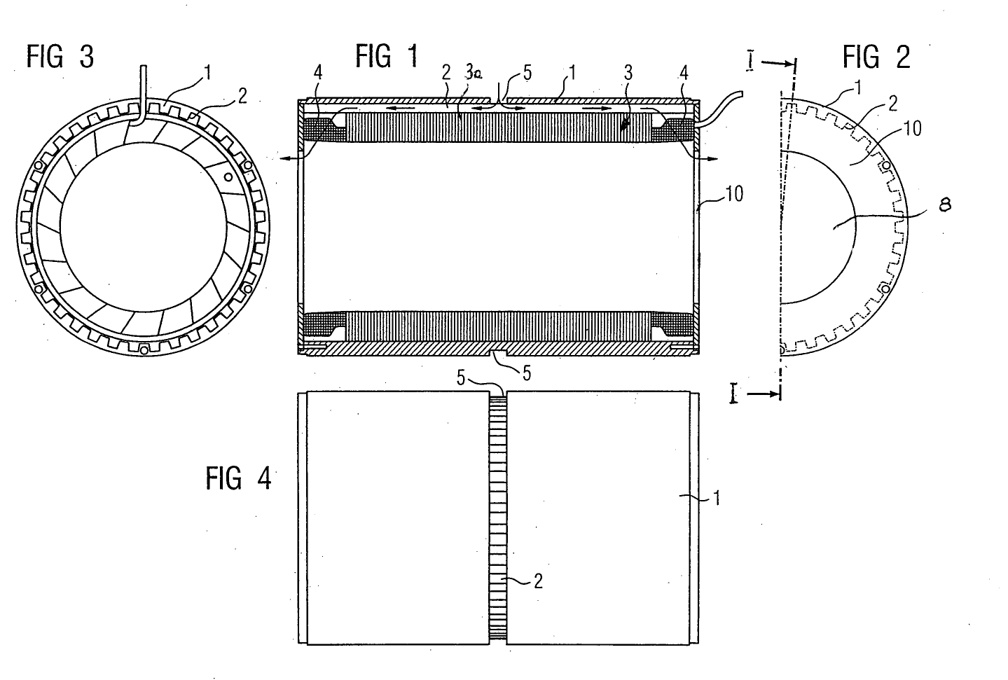

Turning now to the drawing, and in particular to FIG. 1, there is shown a cross section of a first embodiment of an electric machine according to the present invention, taken along the line I-I in FIG. 2. The electric machine includes a housing 1, which is formed with axial grooves 2, and a stator 3, which has a stator body 3a in the form of a stack of laminations and is surrounded by the housing 1. The axial grooves 2 are demarcated by the stator 3 radially to the inside so as to form cooling channels.

The stator 3 further includes winding heads 4, which are located on both axial ends of the stator body 3a, and ring-shaped end covers 10, which close off the stator 3 and are secured to opposite ends of the housing 1. Provided radially inwards of the winding heads 4, the end covers 10 have each a central port 8 (FIG. 2) for coolant, e.g. gas, air, etc. The covers 10 may either rest against the winding heads 4 or be slightly distanced thereform to define a small gap. Formed in midsection (axial center) of the housing 1 is a circumferential gap 5 to provide a further coolant port.

Depending on which of the cooling ports 5 and 8 is used as inlet and outlet, two cooling paths can be realized in the electric machine according to the present invention. in one cooling path, which is indicated in FIG. 1 by the arrows, the central gap 5 represents the inlet port for the coolant which thus flows through the central gap 5 and from there in opposite directions along the axial cooling channels in form of the grooves 2 to the respective winding heads 4, through the winding heads 4 and out of the housing 1 through the central ports 8, representing thus the coolant outlet, in the covers 10. Of course, the coolant path may be realized in reverse direction, which, in fact, is currently preferred because cold coolant is forced to flow first through the winding heads 4, which constitute the hot points in the active part (stator 3) of the electric machine, so that the cooling action is most effective. In this case, the coolant path is thus as follows: Coolant enters through the central ports 8, now representing the coolant inlet, on opposite sides of the housing 1, and is forced through the winding heads 4. As pressure builds up in the area of the winding heads 4, coolant is able to then flow along the axial coolant channels (grooves) 2 from the drive and opposite sides toward the central gap 5, which now represents the coolant outlet, for exiting the electric machine.

Although not shown in detail, the gap 5 may also be realized by radial holes spaced about the circumference of the housing 1.

As shown in the lower half of FIG. 1, the housing 1 buts with its inside surface against the stator body 3a of the stator 3. As a consequence, the housing 1 in conjunction with the stator body 3a and the grooves 2 demarcate the cooling channels which can be seen best in FIG. 3, which is a front view of the electric machine from the left hand side in FIG. 1 with the respective end cover 10 being removed for ease of illustration.

FIG. 4, which is a plan view of the electric machine, shows that the central gap 5 for incoming or outgoing coolant can be made through plain turning. The cooling channels (grooves) 2 can be seen in the area of the gap 5.

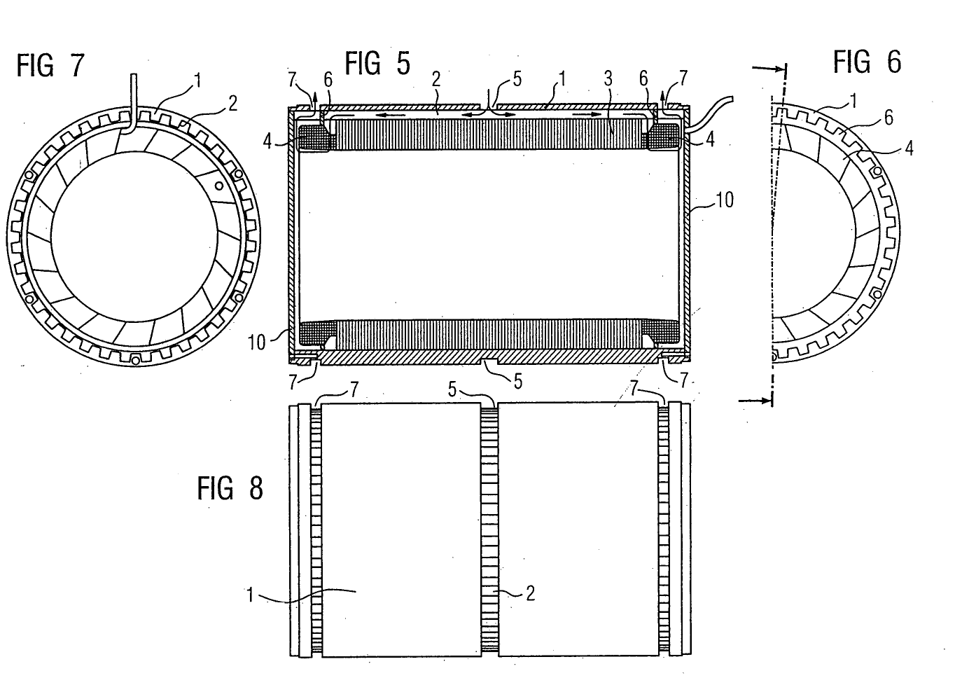

Turning now to FIG. 5, there is shown a cross section of a second embodiment of an electric machine according to the present invention. Parts corresponding with those in FIG. 1 are denoted by identical reference numerals and not explained again. The description below will center on the differences between the embodiments. In this embodiment, provision is made for a ring-shaped disk 6 between each of the winding heads 4 and the housing 1. The disks 6 are contoured to complement a contour of the housing 1 with its grooves 2 so that the disks 6 can be snug fitted in place, as best seen in FIG. 6, which is a partial side view of the electric machine from the right hand side in FIG. 5, with the cover 10 being removed. FIG. 7 is a front view of the electric machine from the left hand side in FIG. 5, with removed disk 6 to illustrate again the cooling channels (grooves) 2 in the housing 1.

As is further shown in FIG. 5, the end covers 10 are solid and thus devoid of any coolant port. The covers 10 are secured to the housing 1 at a distance to the winding heads 4 to define respective gaps.

As a consequence of the disks 6, the coolant flow is forced through the winding heads 4, when entering through coolant port 5 in the middle of the housing 1. In view of the gaps between the end covers 10 and the adjacent winding heads 4, coolant is able to flow around the winding heads 4 and exits the housing 1 through radial coolant ports 7 of the housing 1 in an area of the winding heads 4. The radial coolant ports 7 are formed by circumferential gaps, whereby the coolant can be forced to effectively flow completely about the respective winding heads 4, by providing the radial coolant ports as close as possible to the disks 6. The flow of coolant is indicated in FIG. 5 by arrows. It will be appreciated by persons skilled in the art that the coolant flow can, of course, be reversed as well, as described in conjunction with the embodiment of FIG. 1, so as to provide a better cooling action of the winding heads 4.

FIG. 8, which is a plan view of the electric machine, shows that the central gap 5 and coolant ports 7 for incoming or outgoing coolant can be made simply by hollowing out the housing 1 provided with the grooves 2.

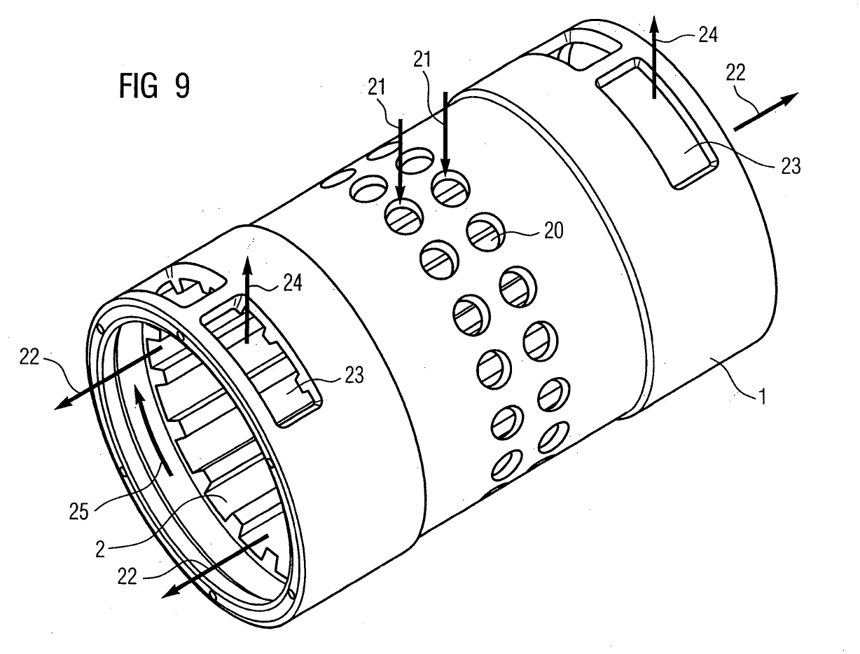

Referring now to FIG. 9, there is shown a top perspective view of a third embodiment of an electric machine according to the present invention, having a housing 1 which is formed in midsection (axial center) with a plurality of pairs of apertures 20, which are evenly spaced apart about the circumference of the housing 1, for introduction of coolant, as indicated by arrows 21. After entry into the housing 1, the coolant, e.g. gas or air, flows in axial direction through cooling channels (grooves) 2 in a direction of arrows 22, and ultimately exits, as indicated by arrows 24, in radial direction through coolant ports 23 formed in proximity of the axial housing end portions. In the nonlimiting example of FIG. 9, the coolant ports 23 have a rectangular configuration, although other configurations are, of course, conceivable as well.

As shown in FIG. 9, the grooves 2 inside the housing 1 are constructed to end shy of the axial end portions of the housing 1 so that the coolant flow can be routed in proximity of the housing end portions also in a circumferential direction, as indicated by arrow 25. As a result, even, when a coolant port 23 should be obstructed, once the electric machine has been assembled and installed, the circumferential flow of coolant enables its exit via one or more of the other coolant ports 23. For ease of illustration, only two coolant ports 23 are shown in FIG. 9, although more coolant ports may, of course be provided.

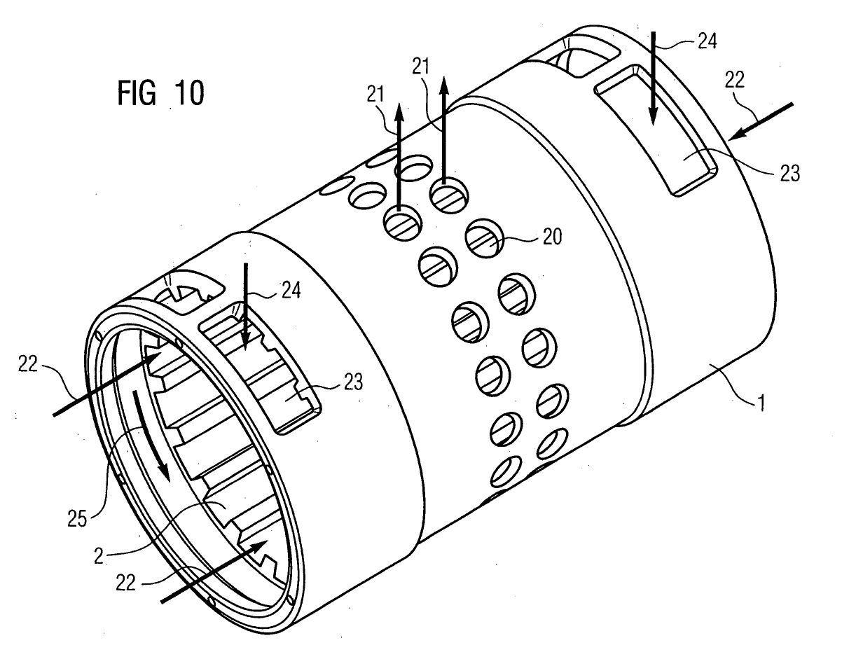

FIG. 10 shows the same housing 1 as illustrated in FIG. 10, with the difference residing merely in the flow path of coolant, which in FIG. 10 is routed in opposite direction. In other words, coolant enters the housing 1 through the coolant ports 23 and then flows in axial direction toward the axial center of the housing 1 for exit through the apertures 20. This coolant path thus allows a cooling of the winding heads 4 first.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. An electric machine, comprising:
a housing defining an axis and having a coolant port disposed in an axial center of the housing, and
a cylindrical stator surrounded by the housing and having a stator body in the form of a plurality of stacked laminations, said stator having opposite axial ends terminating in winding heads,
wherein at least one of the housing and stator is constructed to have cooling channels extending in an axial direction and communicating with the coolant port to allow a flow of coolant from the coolant port via the cooling channels to the winding heads, or in opposite direction from the winding heads via the cooling channels to the cooling port.

2. The electric machine of claim 1, wherein the coolant port includes plural apertures spaced about a circumference of the housing.

3. The electric machine of claim 1, wherein the cooling channels are formed by axial grooves in the housing.

4. The electric machine of claim 1, wherein the cooling channels are formed by axial grooves or channels in the stator.

5. The electric machine of claim 1, and further comprising a ring-shaped disk disposed between each of the winding heads and the housing for forcing the coolant to flow through the winding heads.

6. The electric machine of claim 5, wherein the housing has opposite end surfaces formed with further coolant ports radially inwards of the winding heads.

7. The electric machine of claim 5, wherein the housing has axial end portions formed with further coolant ports radially outwards of the winding heads.

8. The electric machine of claim 7, wherein the further coolant ports are disposed in axial direction immediately adjacent to the disks.

9. The electric machine of claim 1, wherein the housing has opposite axial end portions, said cooling channels being dimensioned to end shy of the axial end portions to allow flow of coolant in a circumferential direction.

10. The electric machine of claim 2, wherein the apertures are formed in pairs about the circumference of the housing.

11. The electric machine of claim 7, wherein the further coolant ports have a rectangular configuration.

12. A method of cooling an electric machine having a cylindrical housing in surrounding relationship to a stator, comprising the steps of:
directing a coolant into the housing in an area of an axial center of the housing;
guiding the coolant in both axial directions to opposite winding heads of the stator; and
routing the coolant through the winding heads radially inwards.

13. The method of claim 12, wherein the routing step includes the step of guiding the coolant about the winding heads and radially outwards.

14. A method of cooling an electric machine having a cylindrical housing in surrounding relationship to a stator, comprising the steps of:
directing a coolant through winding heads on both axial ends of the stator radially inwards;
guiding the coolant from the winding heads to an axial center of the stator; and
routing the coolant from an area of the axial center of the housing to the outside.

15. The method of claim 14, wherein the directing step includes the step of guiding the coolant about the winding heads.
